(19) United States
(12) Patent Application Publication
(10) Pub. No.: US 2007/0147085 A1
(43) Pub. Date: Jun. 28, 2007

(54) Light guide plate with V-shaped refraction interface

(75) Inventors: Xiong-Biao Huang, Shenzhen (CN); Liao-Liao Zhu, Shenzhen (CN); Yu-Liang Huang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/641,918

(22) Filed: Dec. 19, 2006

(30) Foreign Application Priority Data
Dec. 23, 2005 (TW) 94146356

(51) Int. Cl. F21V 7/04

(52) U.S. Cl. 362/615

(57) ABSTRACT

An exemplary light guide plate (2) includes a light output surface (21) on one side of the light guide plate; a bottom surface (22) on an opposite side of the light guide plate; and a plurality of V-shaped refraction interfaces (24) disposed between the light output surface and the bottom surface. The V-shaped refraction interfaces are formed in the light guide plate, which prevents the V-shaped refraction interfaces being pressed by other optical elements. That is, the V-shaped refraction interfaces are secure during assembly and transportation of a backlight module employing the light guide plate. Moreover, the V-shaped refraction interfaces do not occupy a large amount of space, which means that the backlight module can be made thinner.

### FIELD OF THE INVENTION

The present invention relates to light guide plates for use in products such as liquid crystal displays (LCDs) or the like, and more particularly to a light guide plate having V-shaped refraction interface therein.

### BACKGROUND

A typical LCD device includes a liquid crystal display panel, and a backlight system mounted under the liquid crystal display panel. The backlight system mainly includes a light source and a light guide plate. The light guide plate is generally made of a transparent acrylic plastic, and is used for guiding the light emitted by the light source in order to uniformly illuminate the liquid crystal display panel.

In order to diffuse the light and emit it uniformly from a top surface of the light guide plate, protrusions or recesses are provided at a bottom surface of the light guide plate. Alternatively, a pattern of light diffusion dots can be formed on the bottom surface of the light guide plate.

Referring to FIG. 5, a conventional liquid crystal display device 100 includes a liquid crystal display panel 110, and a backlight module 120 disposed at a bottom side of the liquid crystal panel 110. The backlight module 120 includes a diffusion sheet 121, a light guide plate 122, a light source 123, and a reflective sheet 124 arranged from top to bottom in that order. The light guide plate 122 includes a light output surface 11, and a bottom surface 12 opposite to the light output surface 11. The light output surface 11 includes a plurality of V-shaped refraction interface 13 orientated parallel to each other thereon. The light source 123 is a plurality of cold cathode fluorescent lamps (CCFLs) arranged parallel to each other between the reflective sheet 124 and the light guide plate 122.

In operation, part of the light emitted from the light source 123 directly propagates within the light guide plate 122 toward the V-shaped refraction interface 13, and another part of the light is reflected by the light reflective sheet 124 and then enters into the light guide plate 122 and propagates towards the V-shaped refraction interface 13. Almost all the light emitted from the light source 123 is refracted and concentrated by the V-shaped refraction interface 13 after leaving the light output surface 11 of the light guide plate 122. After that, the light passes through the diffusion sheet 121 to illuminate the liquid crystal display panel 110.

However, the V-shaped refraction interface 13 is disposed on the light output surface 11 of the light guide plate 122, which contacts the diffusion sheet 121 directly. As a result, the V-shaped refraction interface 13 is liable to be damaged during assembly or transportation. In addition, the V-shaped refraction interface 13 makes the backlight module 120 unduly thick.

It is therefore desirable to provide a light guide plate which can overcome the above-described deficiencies.

### SUMMARY

A light guide plate includes a light output surface on one side of the light guide plate; a bottom surface on an opposite side of the light guide plate to the light output surface; and a plurality of V-shaped refraction interface between the light output surface and the bottom surface.

Other advantages and novel features will become more apparent from the following detailed description when taken in conjunction with the accompanying drawings.

### BRIEF DESCRIPTION OF THE DRAWINGS

FIG. 1 is an exploded, isometric view of a liquid crystal display device employing a light guide plate according to a first embodiment of the present invention.

FIG. 2 is an exploded, isometric view of a liquid crystal display device employing a light guide plate according to a second embodiment of the present invention.

FIG. 3 is an exploded, isometric view of a liquid crystal display device employing a light guide plate according to a third embodiment of the present invention.

FIG. 4 is an exploded, isometric view of a liquid crystal display device employing a light guide plate according to a fourth embodiment of the present invention.

FIG. 5 is an exploded, side-on view of a liquid crystal display device employing a conventional light guide plate.

### DETAILED DESCRIPTION OF PREFERRED EMBODIMENTS

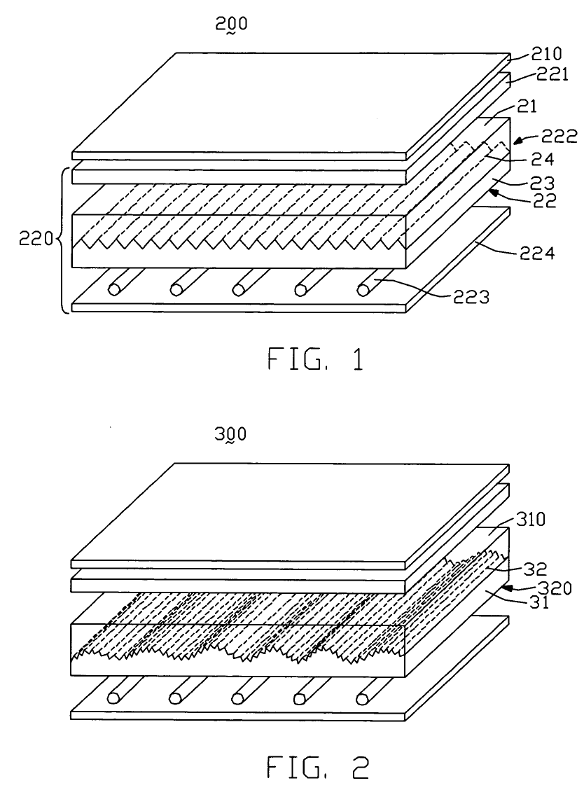

Referring to FIG. 1, this is an exploded, isometric view of a liquid crystal display device employing a light guide plate according to a first embodiment of the present invention. The liquid crystal display device 200 includes a liquid crystal display panel 210, and a backlight module 220 disposed under the liquid crystal panel 210.

The backlight module 220 includes a diffusion sheet 221, a light guide plate 222, a light source 223, and a reflective sheet 224 arranged from top to bottom in that order. The light guide plate 222 includes a light output surface 21, a bottom surface 22 opposite to the light output surface 21, and a side surface adjacent to the light output surface 21. Moreover, the light guide plate 222 includes a plurality of rectilinear V-shaped refraction interface 24 therein. A distance between the V-shaped refraction interface 24 and the light output surface 21 is equal to a distance between the V-shaped refraction interface 24 and the bottom surface 22. Each of the V-shaped refraction interface 221 spans from one lateral side of the light guide plate 222 to an opposite lateral side of the light guide plate 222. The V-shaped refraction interface 24 is continuously aligned and are oriented parallel to the side surface 23, and the V-shaped refraction interfaces 24 has essentially identical heights. The light source 223 is a plurality of cold cathode fluorescent lamps (CCFLs) aligned in parallel between the reflective sheet 224 and the light guide plate 222.

In operation, part of the light emitted from the light source 223 directly propagates within the light guide plate 222 toward the V-shaped refraction interface 24, and another part of the light is reflected by the light reflective sheet 224 before entering into the light guide plate 222 and propagating toward the V-shaped refraction interface 23. Almost all the light emitted from the light source 223 is refracted and concentrated by the V-shaped refraction interface 23 in the light guide plate 22 before it is outputted from the light output surface 21 of the light guide plate 222. After that, the light passes through the diffusion sheet 221 to illuminate the liquid crystal display panel 210.

The V-shaped refraction interface 24 may be formed using a laser molding method, in any desired position between the light output surface 21 and the bottom surface 22. For example, the V-shaped refraction interface 24 can be formed adjacent to the light output surface 21, or adjacent to the bottom surface 22. In an alternative embodiment, the light source 223 may be disposed adjacent to the side surface 23 of the light guide plate 222. In such case, the light source 223 can be a single CCFL.

In summary, the V-shaped refraction interface 24 being formed within the light guide plate 222 prevent the diffusion sheet 221 from directly contacting the V-shaped refraction interface 24. That is, the V-shaped refraction interface 24 is protected from damage during assembly and transportation of the backlight module 220. Furthermore, the V-shaped refraction interface 24 do not necessarily add to a thickness of the light guide plate 222, so that the light guide plate 222 and the backlight module 220 can be compact.

Referring to FIG. 2, this is an exploded, isometric view of a liquid crystal display device employing a light guide plate according to a second embodiment of the present invention. The liquid crystal display device 300 has a structure similar to that of the liquid crystal display device 200 of the first embodiment. The V-shaped refraction interface 32 of the light guide plate 31 is disposed between the light output surface 310 and the bottom surface 320. However, the V-shaped refraction interface 32 has a different height, thus forming a waveform-shaped surface. The V-shaped refraction interface 32 is protected from damage during assembly and transportation of the liquid crystal display device 300. Furthermore, the light guide plate 31 can be thin and compact.

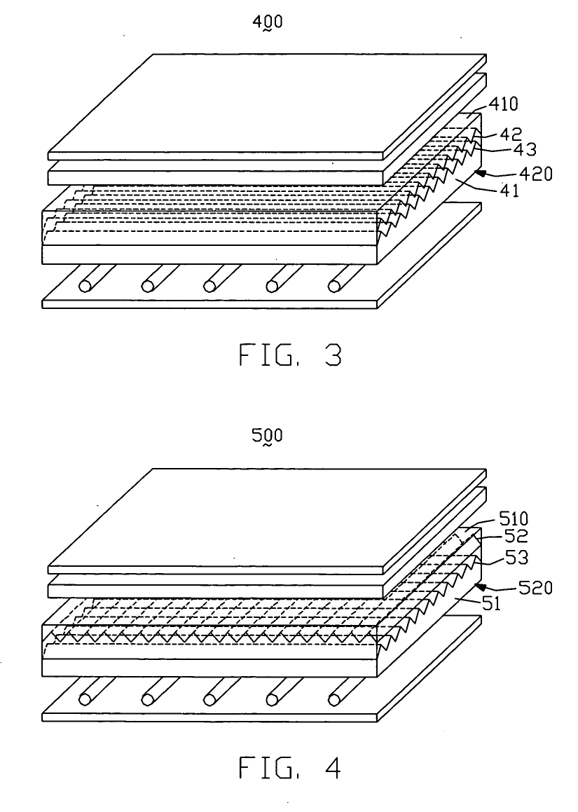

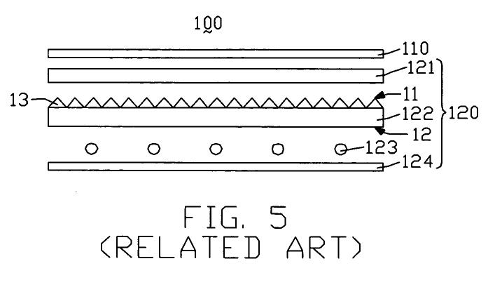

Referring to FIG. 3, this is an exploded, isometric view of a liquid crystal display device employing a light guide plate according to a third embodiment of the present invention. The liquid crystal display device 400 has a structure similar to that of the liquid crystal display device 200 of the first embodiment. The light guide plate 41 includes V-shaped refraction interface 42 and V-shaped refraction interface 43 disposed between the light output surface 410 and the bottom surface 420. The V-shaped refraction interfaces 42 and 43 form a two-layered structure in the light guide plate 41, and the orientation of the V-shaped refraction interfaces 42 and 43 of the two layers is the same. The V-shaped refraction interfaces 42 and 43 are protected from damage during assembly and transportation of the liquid crystal display device 400. Furthermore, the light guide plate 41 can be thin and compact.

Referring to FIG. 4, this is an exploded, isometric view of a liquid crystal display device employing a light guide plate according to a third embodiment of the present invention. The liquid crystal display device 500 has a structure similar to that of the liquid crystal display device 500 of the first embodiment. The light guide plate 51 includes V-shaped refraction interface 52 and V-shaped refraction interface 53 disposed between the light output surface 510 and the bottom surface 520. The V-shaped refraction interfaces 52 and 53 form a two-layered structure in the light guide plate 51, the V-shaped refraction interfaces 52 and 53 of the two layers are oriented at right-angles to each other. The V-shaped refraction interfaces 52 and 53 are protected from damage during assembly and transportation of the liquid crystal display device 500. Furthermore, the light guide plate 51 can be thin and compact.

Various modifications and alterations to the above-described embodiments are possible. For example, the orientation of the V-shaped refraction interfaces in the light guide plate is not limited to the orientations described above. For example, the V-shaped can be oriented obliquely to the side surface of the light guide plate. In another example, there can be three or more layers of V-shaped refraction interfaces in the one light guide plate.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light guide plate, comprising:
a light output surface on one side of the light guide plate;
a bottom surface on an opposite side of the light guide plate; and
a plurality of V-shaped refraction interfaces between the light output surface and the bottom surface.

2. The light guide plate as claimed in claim 1, wherein the V-shaped refraction interfaces are laser molded V-shaped refraction interfaces.

3. The light guide plate as claimed in claim 2, wherein each of the V-shaped refraction interfaces spans from one lateral side of the light guide plate to an opposite lateral side of the light guide plate, and the V-shaped refraction interfaces are aligned parallel to each other.

4. The light guide plate as claimed in claim 1, wherein the V-shaped refraction interfaces have essentially the same height.

5. The light guide plate as claimed in claim 1, wherein the V-shaped refraction interfaces are of varying heights, thus forming a waveform-shaped surface.

6. The light guide plate as claimed in claim 1, wherein a distance between the V-shaped refraction interfaces and the light output surface is equal to a distance between the V-shaped refraction interfaces and the bottom surface.

7. The light guide plate as claimed in claim 1, wherein the V-shaped refraction interfaces are formed adjacent to the light output surface.

8. The light guide plate as claimed in claim 1, wherein the V-shaped refraction interfaces are formed adjacent to the bottom surface.

9. The light guide plate as claimed in claim 1, wherein the V-shaped refraction interfaces are formed in a two-layered arrangement.

10. The light guide plate as claimed in claim 9, wherein an orientation of the V-shaped refraction interfaces in one of the layers is the same as an orientation of the V-shaped refraction interfaces in the other layer.

11. The light guide plate as claimed in claim 9, wherein an orientation of the V-shaped refraction interfaces in one of the layers is at right angles to an orientation of the V-shaped refraction interfaces in the other layer.

12. A light guide plate, comprising:
a light output surface on one side of the light guide plate;
a bottom surface on an opposite side of the light guide plate; and
a plurality of non-linear refraction interfaces between the light output surface and the bottom surface so as to divide the light guide plate into two parts sharing said interfaces.

13. The light guide plate as claimed in claim 12, wherein said non-linear refraction interfaces are arranged in two layers.

14. The light guide plate as claimed in claim 12, wherein said non-linear refraction interfaces are arranged with a plurality of units and each of said units further includes a plurality of sub-units.

15. The light guide plate as claimed in claim 13, wherein the non-linear interfaces in said two layers are oriented in different directions.
